(19) United States
(12) Patent Application Publication
(10) Pub. No.: US 2007/0017394 A1
(43) Pub. Date: Jan. 25, 2007

(54) Device for fixing scraper strips to a printing roller scraper

(76) Inventors: Joan Davila Casitas, Riudellots De La Selva (ES); Miquel Vinas Turro, Riudellots De La Selva (ES); Jordi Puig I Vila, Riudellots De La Selva (ES)

Correspondence Address: RATNERPRESTIA, P O BOX 980, VALLEY FORGE, PA, 19482-0980, US

(21) Appl. No.: 10/563,983

(22) PCT Filed: Jul. 10, 2003
(86) PCT No.: PCT/ES03/00355

§ 371 Date: Jun. 27, 2006

(51) Int. Cl. B41F 31/00

(52) U.S. Cl. 101/350.6

(57) ABSTRACT

The invention relates to a device for fixing scraper strips to a printing roller scraper. The inventive device comprises at least one magnetic element (3) which is configured and disposed such as to hold a first face of a longitudinal support portion (1a) of at least one scraper strip (1) in firm contact with a support surface of a body (2) of said scraper (10), a second free longitudinal portion (1b) of said scraper strip (1) occupying a projecting position. Alternatively, the magnetic element (3) is also configured and disposed such as to maintain a hold-down plate (5) in firm contact with a second face of the support portion (1a) of the scraper strip (1), whereby said second face is located opposite the aforementioned first face which is in contact with the body (2). In this way, the support portion (1a) of the scraper strip (1) is trapped between the hold-down plate (5) and the support surface of the body (2).

### SCOPE OF THE INVENTION

This invention concerns to a device for securing doctor blades to a printing roller doctor assembly, applicable to flexographic printers, for example.

### TECHNICAL BACKGROUND

In many applications in which rollers are used in contact with more or less sticky substances, doctor devices are employed to clean or control the presence of said substance on the roller surface. Usually this doctor takes the form of a blade secured to an elongated body generally located in parallel to a printing roller. This blade has at least one longitudinal supporting portion joined to a supporting surface of said body and another free longitudinal portion that projects outwards cantilevered, the end of which is in contact with the roller. A doctor device is known, for example, in flexographic printers, in which said elongated body has a longitudinal groove facing the printing roller and two of said supporting surfaces located at both sides of the mentioned groove and designed for the installation of a pair of said doctor blades arranged to contact with the roller external surface. The longitudinal groove is suitably closed at its lateral ends so that, when in use, a closed chamber is formed between the groove, the cantilevered portions of the doctor blades and one portion of the roller surface. This chamber is connected to an ink supply source through at least one ink inlet, and is used to ink the roller. Patent EP-A-1302315 describes a hermetic lateral closure for an ink chamber of a doctor device of the type described above.

The securing of the blades to the doctor body has been being achieved by means of releasable securing elements, such as screws, which have the inconvenience of comprising a large number of loose items that require specific tools and a relatively long time for its mounting and dismounting. The international patent application WO 00/78548 proposes an alternative fast-action system for the securing and releasing of the blades to from a printing roller doctor device. This system comprises an elongated clamp and a clamping mechanism designed to press the clamp against the doctor body supporting mechanism designed to press the clamp against the doctor body supporting surface trapping the blade supporting portion between the clamp and the body. This system also includes a movement mechanism which, when operated, moves the clamp counteracting the cited clamping mechanism in order to release the blade. One inconvenience of this system is that it requires a double mechanism; a first mechanism to press the clamp against the body and a second mechanism to counteract said pressure. Because of this, the system is both complicated and expensive. Moreover, in certain embodiments, the cited movement mechanism is driven by compressed air, which involves the additional inconvenience of requiring a compressed air installation.

### BRIEF DESCRIPTION OF THE INVENTION

The purpose of the present invention is to solve or mitigate the previously described inconveniences by providing a device for securing doctor blades to a printing roller doctor assembly that includes releasable securing means to join at least one doctor blade to the body of the doctor assembly, where said releasable securing means are of simple construction and fast, simple application without any need for tools.

The mentioned releasable securing means are characterised in that they comprise at least one magnetic element that is configured and arranged to maintain a first face of said supporting portion of said at least one doctor blade in a firm contact with a surface of said body. In accordance with a first embodiment of the invention, the device includes a pressing element in a firm contact with a second face of the supporting portion of the doctor blade, being said second face opposite to a first face of the doctor blade, which is in contact with the body, so that the supporting portion of the doctor blade is trapped between said pressing element and said body surface. Preferably, the doctor blade is of a material that can be attracted by the magnetic element, although the pressing element ensures firm securing of the doctor blade even in the case in which the doctor blade is made of a non-magnetic or paramagnetic material or not attractable by the magnetic element. In accordance with a second embodiment, the doctor blade is made of a material attractable by the magnetic element with sufficient force to ensure the mentioned firm contact and an adequate positioning of the doctor blade without using the pressing element.

The previous embodiments admit multiple variants. For example, the magnetic element may be imbedded in the supporting surface of the doctor assembly body or in the pressing element and, in both cases, it can be formed by one or more continuous strips or by a plurality of pieces separated along the doctor assembly. Also, the pressing element very material may be constituted by the magnetic element. When the magnetic element is incorporated into the pressing element and the body material is not attractable by the magnetic element, for example, aluminium, then at least one element made of a material attractable by the magnetic material, for example, iron, is imbedded in the body material.

If required to facilitate assembly and disassembly of the doctor blade, the magnetic element, or elements when there are more than one, are linked to a mechanism that is configured and arranged to selectively move one or more of the magnetic elements between a resting position, in which the magnetic force of the magnetic element is attenuated or cancelled, and an operating position, in which the magnetic force of the magnetic element is acting on the doctor blade and/or on said material attractable by the magnetic element, whether included in the pressing element or in the doctor assembly body. The cited mechanism may act by, for example, moving the magnetic element or elements closer to or further away from the material attractable by the magnetic elements in order to increase or reduce the force of magnetic attraction, or by moving one or more of the pieces of the magnetic element in order to arrange them so that their polarities are cancelled in the resting position and add together in the operating position.

With the inclusion of one or more magnetic elements in accordance with this invention, releasable securing means are provided for joining the doctor blade to the body of the doctor assembly, and which are of simple and economic construction and easy and simple to handle without any need for tools or the installation of expensive power supplies.

### BRIEF DESCRIPTION OF THE DRAWINGS

The invention will be better understood from the following detailed description of some embodiments with reference to the accompanying drawings, in which:

FIG. 1 is a diagrammatic transverse section view of a first embodiment of the device of the present invention;

FIGS. 2 and 3 are partial perspective views that show variants with respect to the arrangement of the magnetic elements of the embodiment of FIG. 1;

FIG. 4 is a partial transverse section view of another variant of the first embodiment shown in FIG. 1;

FIG. 5 is a partial transverse section view that shows a second embodiment of this invention, wherein it is not employed a pressing element; and

FIG. 6 is a partial transverse section view of another variant of the first embodiment shown in FIG. 1.

### DETAILED DESCRIPTION OF SOME EMBODIMENTS

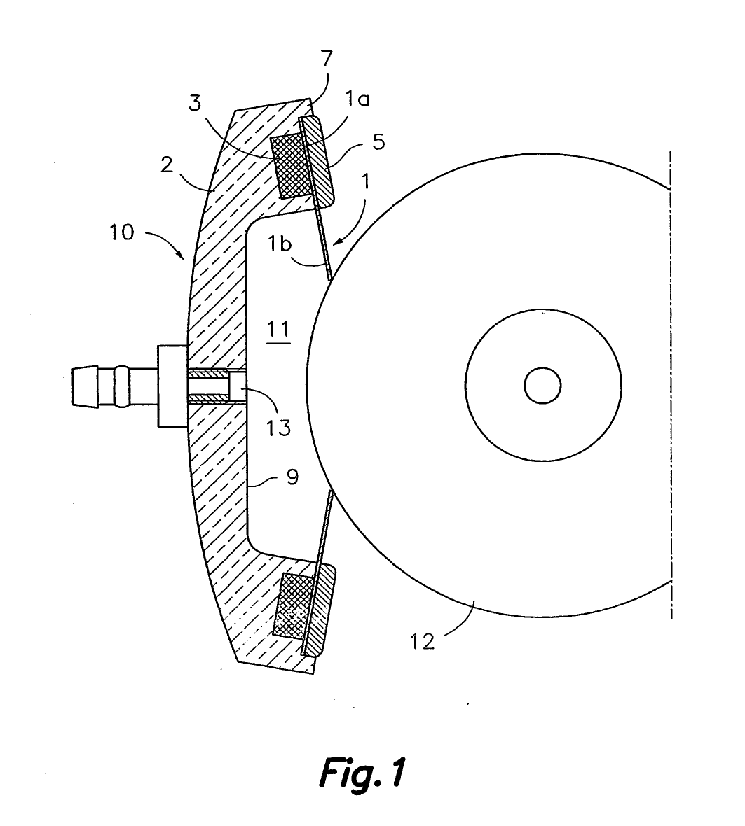

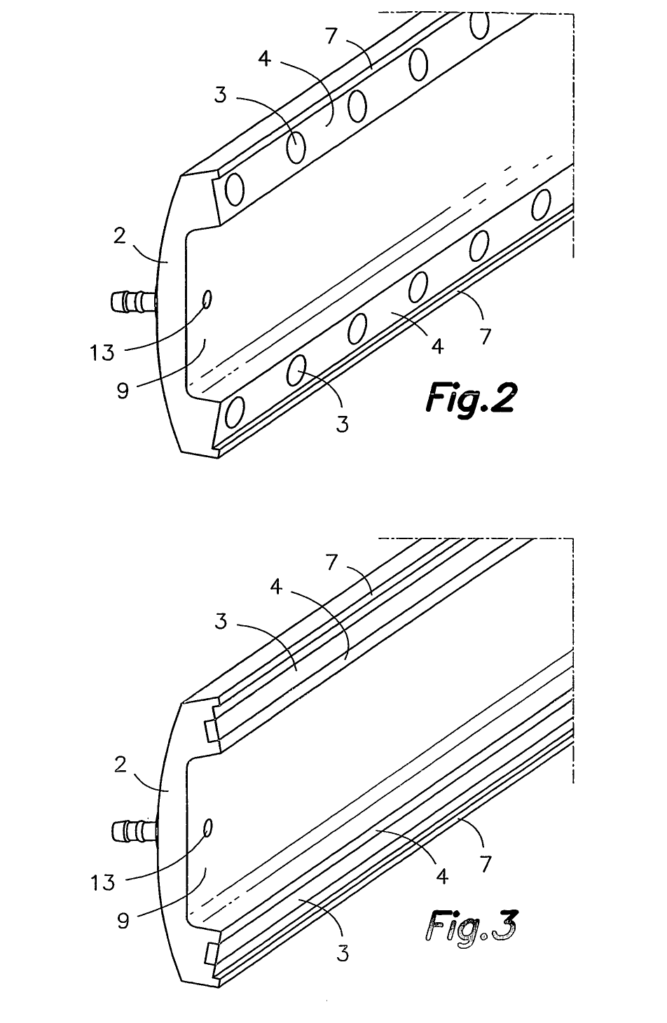

First referring to FIG. 1, there is shown a doctor assembly 10 for a printing roller 12 of a well-known type of flexographic printer. The mentioned doctor assembly 10 comprises an elongated body 2 that has a longitudinal groove 9 facing the printing roller 12 and two supporting surfaces 4 (see FIGS. 2 and 3) located on both sides of the mentioned groove 9. The cited supporting surfaces 4 are designed for the installation of a pair of doctor blades 1 arranged to make contact with the outer surface of the roller 12. Releasable securing means allow at least one longitudinal supporting portion la of each doctor blade 1 to be joined to the body 2 of the doctor assembly 10 so that another free longitudinal portion 1b of said doctor blade 1 is cantilevered. The free ends of said cantilevered portions 1b make elastic contact with the surface of the roller 12. The longitudinal groove 9 is suitably closed at its lateral ends so that, when in use, a closed chamber 11 is formed between the groove 9, said cantilevered portions 1b of the doctor blades 1 and one portion of the roller surface 12 encompassed between the two cantilevered portions 1b. This chamber 11 is connected to an ink supply source through at least one ink inlet 13, and is used to ink the roller 12. Although in the illustrated embodiment the doctor blades securing device of this invention is applied to the securing of the doctor blades 1 to the supporting surfaces 4 of said doctor assembly 10, it could be equally applied to any other type of doctor assembly for printing rollers.

In the securing device in accordance with a first embodiment of this invention shown in FIGS. 1, 4 and 6, the cited releasable securing means comprise at least one magnetic element 3 configured and arranged to maintain a first face of said supporting portion 1a of the at least one doctor blade 1 in a firm contact with the corresponding supporting surface 4 of said body 2, and a pressing element 5 in a firm contact with a second face of the supporting portion 1a of the doctor blade 1 opposite to said first face in contact with the body 2, so that the supporting portion 1a of the doctor blade 1 is trapped between said pressing element 5 and the supporting surface 4 of the body 2.

The arrangement of said at least one magnetic element 3 allows multiple variants. For example, for the variant shown in FIG. 1, the body 2 is, as is normal, made of a non-magnetic material, such as aluminium, and the at least one magnetic element 3 is imbedded in the material of the body 2, while the pressing element 5 includes a material attractable by the magnetic element 3, made of, for example, iron. In FIG. 2, the magnetic element 3 is made up of many pieces imbedded in the material of the body 2 and distributed over the supporting surfaces 4 of the same, and each magnetic element 3 has an active surface that is level with the supporting surface 4 of the body 2. In FIG. 3, the magnetic element 3 is made up of a continuous strip imbedded in the material of the body 2 along the length of each supporting surface 4 of the same, and said continuous strip of the magnetic element 3 has an active surface that is level with the supporting surface 4 of the body 2.

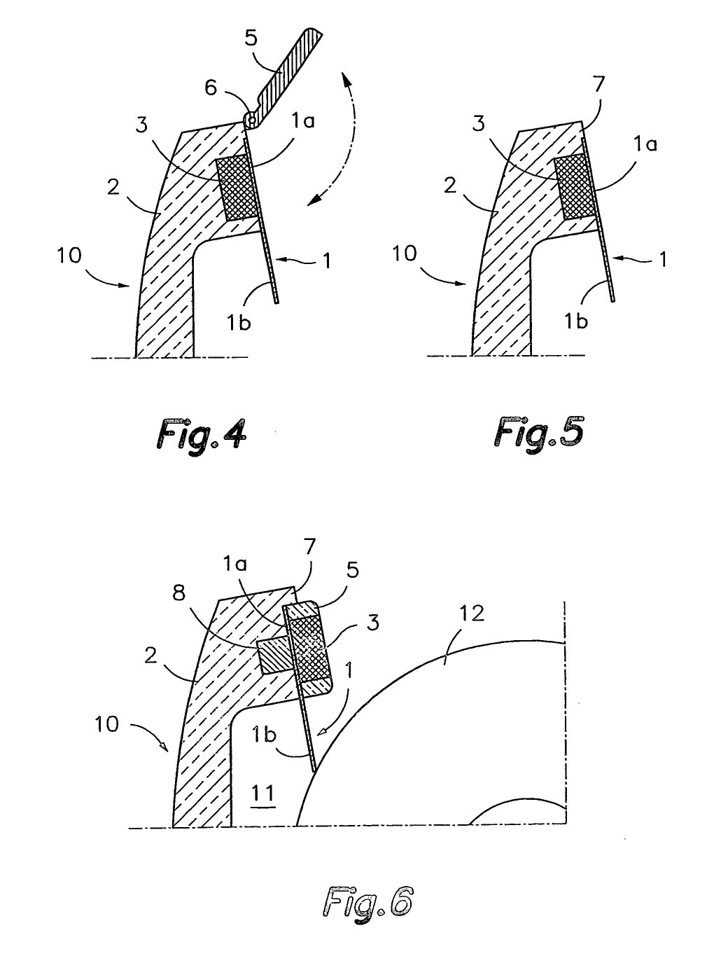

Returning to FIG. 1, in the embodiment shown there, the pressing element 5 is independent of the body 2 and the body 2 comprises a configuration 7 in the form of a longitudinal stop designed to cooperate with an edge of the pressing element 5 in order to position the pressing element 5 in a securing position. Advantageously, this same configuration 7, or other similar configuration, is also employed to position the supporting portion la of the doctor blade 1 in a position suitable for allowing the free portion 1b to be cantilevered. In another variant, just as shown in FIG. 4, the pressing element 5 is linked by one of its edges to the body 2 by means of an articulation 6 so that the pressing element 5 can pivot between an open position and a securing position.

The arrangement of the magnetic element 3 and of the material attractable by the same may be inverted. Thus, in the variant shown in FIG. 6, the at least one magnetic element 3 is imbedded in the pressing element 5 material and has an active surface level with a pressing element 5 surface designed to come into contact with said second face of the supporting surface 1a of the doctor blade 1, while, at least part of the supporting surface 4 of the body 2 includes the material attractable by the magnetic element 3. Evidently, in an analogous manner than in the variants of FIGS. 2 and 3, in this case also the magnetic element 3 may comprise a plurality of pieces imbedded in the pressing element 5 material along the length of the same, or at least one continuous strip imbedded in the pressing element 5 material along the length of the same. Even the very magnetic element 3 may be made of the material of said pressing element 5. In the usual case in which the body 2 material is non-magnetic or paramagnetic, for example aluminium, at least one element 8 made of a material attractable by the magnetic element 3 is imbedded in the body 2 material and has a surface level with said supporting surface 4 of the body 2 as shown in FIG. 6. However, the body 2, or at least the supporting surface 4 of the same, could similarly be made of a material attractable by the magnetic element 3 imbedded in the pressing element 5.

Because of the existence of the mentioned pressing element 5 in combination with the supporting surface 4 of the body 2 and the one of more magnetic elements 3, the doctor blade 1 could be made of a non-magnetic or paramagnetic material, or not attractable by a magnetic element, for example aluminium or plastic. This is because, due to the relative thinness of the doctor blade 1, the magnetic field generated by the magnetic element or elements 3 easily passes through the doctor blade 1 and attracts the pressing element 5 against the supporting surface 4 with sufficient force to trap the supporting portion 1a of the doctor blade 1 between them.

However, in accordance with a second embodiment shown in FIG. 5, the doctor blades securing device of this invention uses a doctor blade 1 made of a material attractable by a magnetic element, such as steel, which is usual in such applications, and said releasable securing means comprise at least one magnetic element 3 configured and arranged to maintain a first face of said supporting portion 1a of the at least one doctor blade 1 in a firm contact with a supporting surface 4 of said body 2. It can be seen that the pressing element 5 of the first embodiment is not used here because the force of attraction of the one or more magnetic elements 3 is sufficient to retain the doctor blade 1 in position. It is also advantageous here to incorporate a configuration 7 in the form of a stop to cooperate with an edge of the doctor blade 1 on the correct positioning of the same. With respect to the arrangement of the one or more magnetic elements 3 in the body 2, all that is described above in relation to FIGS. 2 and 3 is applicable and, of course, the fact that the doctor blade 1 is of a material attractable by the magnetic element 3 is not an obstacle for including also a pressing element 5 analogous to the one described above in relation to the variants of FIGS. 1 and 4.

The embodiments illustrated in the figures are representative of a basic construction of the invention, in which the magnetic element 3, whether incorporated into the body 2 or to the pressing element 5, is formed by one or more permanent magnets firmly imbedded in a predetermined position. However, in accordance with a non illustrated embodiment, the present invention also foresees for means to selectively attenuate or cancel the magnetic force of the magnetic element 3 in order to facilitate the disassembly of the doctor blade 1. In accordance with one variant, the at least one magnetic element 3 is a permanent magnet linked to a mechanism configured and arranged to selectively move the magnetic element 3 between a resting position, in which the magnetic force of the magnetic element 3 is attenuated or cancelled, and an operating position, in which the magnetic force of the magnetic element 3 acts on the doctor blade 1 and on said material attractable by the magnetic element 3 included in the pressing element 5. This can be achieved by moving the magnetic element 3 so that, in said resting position, the cited active surface of the magnetic element 3 is sunken below and away from the supporting surface 4 of the body 2, while in said operating position, the cited active surface of the magnetic element 3 is level with the supporting surface 4 of the body 2. Alternatively, when the magnetic element 3 is formed by several pieces, the mechanism can move one of more of such magnetic pieces so that, in said resting position, the cited magnetic element 3 pieces are arranged in such a fashion that their polarities cancel, whereas in said operating position, the cited magnetic element 3 pieces are arranged so that their polarities add together. In both cases, the cited mechanism can be easily constructed by a cam system, eccentric, or the like.

Another embodiment variant (not shown) that is suitable for selectively attenuating or cancelling the magnetic force of the magnetic element 3 consists in providing the magnetic element 3 in the form of one or more electromagnets connected to a power supply and control circuit designed to selectively activate and deactivate the magnetic force of the electromagnet or electromagnets The described and illustrated embodiments are for merely illustrative purposes only and under no circumstances limit the scope of the present invention, which is defined in the attached claims.

1. A device for securing doctor blades to a printing roller doctor assembly of the type that comprises releasable securing means for joining at least one longitudinal supporting portion of a doctor blade to a body of said doctor, assembly said doctor blade having a cantilevered free longitudinal portion, wherein said releasable securing means comprises at least one magnetic element configured and arranged to maintain a first face of said supporting portion of the at least one doctor blade in firm contact with a supporting surface of said body and a pressing element in firm contact with a second face of the supporting portion of the doctor blade opposite to said first face in contact with the body, with the supporting portion of the doctor blade being trapped between said pressing element and said supporting surface of the body.

2. A device in accordance with claim 1, wherein the at least one magnetic element is imbedded in the material of the body and has an active surface that is level with the supporting surface of the body and the pressing element includes a material attractable by the magnetic elements.

3. A device in accordance with claim 2, wherein the magnetic element is formed by at least one continuous strip imbedded in the material of the body along the length of the body.

4. A device in accordance with claim 2, wherein the magnetic element is formed by a plurality of pieces imbedded in the material of the body and distributed along the length of the body.

5. A device in accordance with claim 1, wherein the at least one magnetic element is imbedded in the material of the pressing element and has an active surface level with a pressing element surface designed to come into contact with said second face of the doctor blade, at least part of the supporting surface of the body, including a material attractable by the magnetic elements.

6. A device in accordance with claim 5, wherein the magnetic element is formed by at least one continuous strip imbedded in the material of the pressing element along the length of the pressing elements.

7. A device in accordance with claim 5, wherein the magnetic element is formed by a plurality of pieces imbedded in the material of the pressing element along the length of the pressing element.

8. A device in accordance with claim 5, wherein the magnetic element is made of the same material as that of said pressing elements.

9. A device in accordance with claim 5, wherein, in the case where the body material is not magnetic or is paramagnetic, at least one element of a material attractable by the magnetic element is imbedded in the body material and has a surface that is level with said supporting surface of the body.

10. A device in accordance with any of claims claim 5, wherein said at least one body is, at least on the supporting surface of the same, made of a material attractable by the magnetic elements.

11. A device in accordance with claim 2, wherein the at least one magnetic element is linked to a mechanism configured and arranged to selectively move the magnetic element between a resting position, in which the magnetic force of the magnetic element is attenuated or cancelled, and an operating position, in which the magnetic force of the magnetic element acts on the doctor blade and on the material attractable by the magnetic element included in the pressing element.

12. A device in accordance with claim 11, wherein, in said resting position, the cited active surface of the magnetic element is sunken below and away from the supporting surface of the body, while in said operating position, the cited active surface of the magnetic element is level with the supporting surface of the body.

13. A device in accordance with claim 11, wherein the magnetic element is formed by several pieces and, in said resting position, the cited pieces of the magnetic element are arranged so that their polarities are cancelled and, in said operating position, the pieces of the magnetic element are arranged so that their polarities add together.

14. A device in accordance with claim 5, wherein the at least one magnetic element is linked to a mechanism configured and arranged to selectively move the magnetic element between a resting position, in which the magnetic force of the magnetic element is attenuated or cancelled, and an operating position, in which the magnetic force of the magnetic element acts on the doctor blade and on the cited material that is attractable by the magnetic element included in the supporting surface of the body.

15. A device in accordance with claim 14, wherein, in said resting position, the cited active surface of the magnetic element is sunken below and away from the surface of the pressing element, while in said operating position, the active surface of the magnetic element is level with the supporting surface.

16. A device in accordance with claim 14, wherein the magnetic element is formed by several pieces and, in said resting position the cited pieces of the magnetic element are arranged so that their polarities are cancelled and, in said operating position, the pieces of the magnetic element are arranged so that their polarities add together.

17. A device in accordance with claim 2, wherein the at least one magnetic element comprises an electromagnet connected to a power supply and control circuit designed to selectively activate and deactivate the magnetic force of the electromagnet.

18. A device in accordance with claim 1, wherein the pressing element is linked by one of its edges to the body by means of an articulation so that the pressing element can pivot between an open position and a securing position.

19. A device in accordance with claim 1, wherein said pressing element is independent of the body, and the body comprises a configuration designed to cooperate with an edge of the pressing element to place the pressing element in an operating position.

20. A device in accordance with claim 1, wherein the body comprises a configuration designed to cooperate with an edge of the doctor blade to place the doctor blade in an operating position.

21. A device in accordance with claim 1, wherein the doctor blade is made of a non-magnetic or paramagnetic material or is not attractable by a magnetic element.

22. A device for securing doctor blades to a printing roller doctor assembly of the type that comprises releasable securing means for joining at least one longitudinal supporting portion of a doctor blade to a body of said doctor assembly, said doctor blade having a cantilevered free longitudinal portion, wherein the doctor blade is comprised of a material attractable by a magnetic element, and said releasable securing means comprises at least one magnetic element configured and arranged to maintain a first face of said supporting portion of the at least one doctor blade in a firm contact with a supporting surface of said body.

23. A device in accordance with claim 22, wherein said at least one magnetic element is configured and arranged to also maintain a pressing element in a firm contact with a second face of the supporting portion of the doctor blade opposite to said first face in contact with the body, with the supporting portion of the doctor blade being trapped between said pressing element and said supporting surface of the body.

24. A device in accordance with claim 5, wherein the at least one magnetic element comprises an electromagnet connected to a power supply and control circuit designed to selectively activate and deactivate the magnetic force of the electromagnet.
